(19) United States
(12) Patent Application Publication
(10) Pub. No.: US 2015/0060187 A1
(43) Pub. Date: Mar. 5, 2015

(54) STEERING APPARATUS

(71) Applicant: JTEKT CORPORATION, Osaka (JP)

(72) Inventor: Masashi YAMAGUCHI, Toyota-shi (JP)

(21) Appl. No.: 14/454,046

(22) Filed: Aug. 7, 2014

(30) Foreign Application Priority Data
Aug. 29, 2013 (JP) 2013-178492

(51) Int. Cl. B62D 5/04; F16H 25/22

(52) U.S. Cl. CPC B62D 5/0424; B62D 5/0445; F16H 25/2204
USPC 180/444

(57) ABSTRACT

A steering apparatus includes a driving pulley, a driven pulley, a belt wound around the driving pulley and the driven pulley, and a ball screw mechanism that converts a rotation of the driven pulley into a reciprocating movement of a steering shaft. The ball screw mechanism includes a ball screw nut and a plurality of balls provided inside a spiral ball raceway. The ball race way is formed by a first thread groove formed at an outer periphery of the steering shaft and a second thread groove formed at an inner periphery of the ball screw nut. Outer teeth of the driving pulley and the driven pulley and inner teeth of the belt are helical teeth respectively having tooth traces twisted in a direction opposite to the first thread groove and the second thread groove.

### INCORPORATION BY REFERENCE

The disclosure of Japanese Patent Application No. 2013-178492 filed on Aug. 29, 2013 including the specification, drawings and abstract is incorporated herein by reference in its entirety.

### BACKGROUND OF THE INVENTION

1. Field of the Invention

The invention relates to a steering apparatus.

2. Description of Related Art

Some of conventional steering apparatuses for vehicles have been configured as electric power steering apparatuses that convert the rotation of an electric motor into the shaft-direction movement of a steering shaft with a ball screw mechanism to apply an assisting force to a steering system. As such, steering apparatuses that includes an electric motor arranged parallel to a steering shaft and transmit the rotation of the electric motor to a ball screw mechanism via a transmission mechanism composed of a pair of pulleys and a belt have been available (for example, International Patent Application No. 2006/070889 (WO 2006/070889).

In the steering apparatus of WO 2006/070889, respective pulleys have outer teeth at the outer peripheries thereof, and a belt has inner teeth at the inner periphery thereof. The belt is wound around the respective pulleys with the inner teeth meshing with the respective outer teeth. Thus, the belt is prevented from being slipped relative to the respective pulleys when the rotation of an electric motor is transmitted. In addition, there has been proposed in the steering apparatus that the respective outer teeth and the inner teeth are configured as helical teeth having tooth traces twisted relative to the axis lines of the respective pulleys (see FIG. 8 or the like of WO 2006/070889). Thus, vibrations and abnormal noises caused when the outer teeth of the respective pulleys and the inner teeth of the belt mesh with each other are reduced.

In recent years, it has been requested that such a steering apparatus be downsized and reduced in weight, and the downsize and lightweight of an electric motor has been discussed to fulfill the request. However, it is generally difficult to ensure the sufficient output performance of the electric motor in the downsized electric motor. Therefore, if higher priority is placed on the downsize and lightweight of the electric motor, the assisting performance of the steering apparatus may not be maintained.

### SUMMARY OF THE INVENTION

The invention provides a steering apparatus that can be downsized and reduced in weight with its assisting performance maintained.

An aspect of the invention provides a steering apparatus including: a driving pulley that rotates with driving of an electric motor; a driven pulley arranged coaxially with a steering shaft; a belt wound around the driving pulley and the driven pulley; and a ball screw mechanism that converts a rotation of the driven pulley into a reciprocating movement of the steering shaft, wherein: the ball screw mechanism has a ball screw nut that integrally rotates with the driven pulley, and a plurality of balls provided inside a spiral ball raceway formed by a first thread groove formed at an outer periphery of the steering shaft and a second thread groove formed at an inner periphery of the ball screw nut, the first thread groove and the second thread groove facing each other; the driving pulley and the driven pulley respectively have outer teeth at outer peripheries thereof, and the belt has, at an inner periphery thereof, inner teeth to mesh with the respective outer teeth, and the respective outer teeth and the inner teeth are helical teeth respectively having tooth traces twisted in a direction opposite to the first thread groove and the second thread groove.

According to the above configuration, a steering apparatus can be downsized and reduced in weight with its assisting performance maintained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a partial cross-sectional view showing the schematic configuration of a steering apparatus of an embodiment;

FIG. 2 is an enlarged cross-sectional view in the vicinity of a steering force assisting unit of the embodiment;

FIG. 3 is a plan view of the ball screw nut of the embodiment;

FIG. 4 is a cross-sectional view of the transmission mechanism of the embodiment (cross-sectional view taken along the line IV-IV in FIG. 2);

FIG. 5 is a partial cutaway view showing the front face structure of the transmission mechanism of the embodiment;

FIG. 6A is a schematic diagram showing force acting on the ball screw nut of the embodiment; and

FIG. 6B is a schematic diagram showing force acting on the ball screw nut of a comparative example.

### DETAILED DESCRIPTION OF EMBODIMENTS

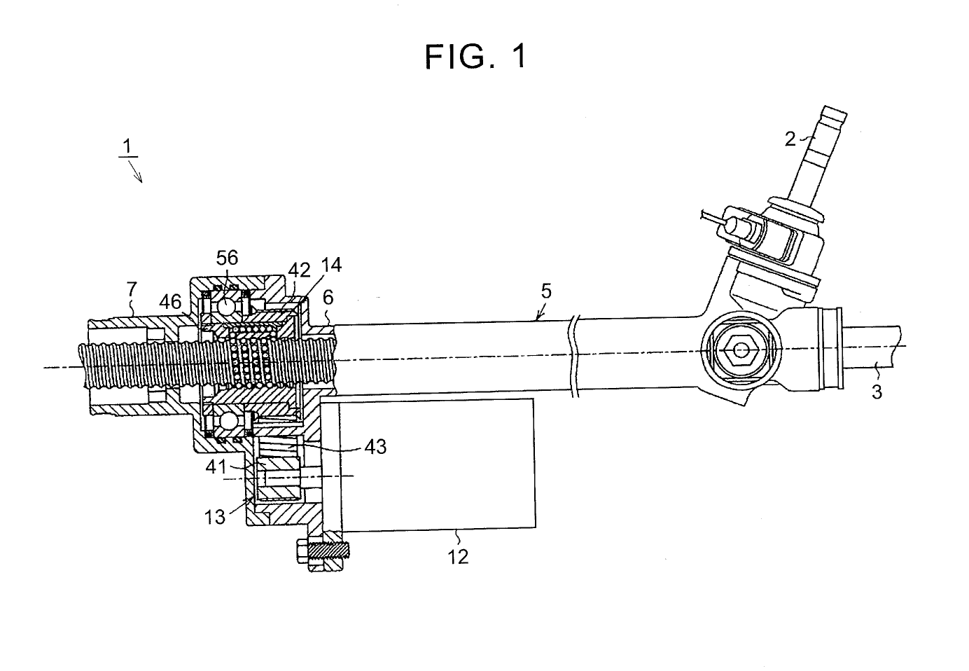

Hereinafter, an embodiment of a steering apparatus will be described with reference to the drawings. As shown in FIG. 1, a steering apparatus 1 includes a pinion shaft 2 that rotates with a steering operation and a rack shaft 3 serving as a steering shaft that moves reciprocally in a shaft direction with the rotation of the pinion shaft 2 to change the steering angle of a steering wheel (not shown). In addition, the steering apparatus 1 has a rack housing 5 serving as a housing in which the rack shaft 3 is arranged to be reciprocally movable.

The rack housing 5 has a first housing 6 formed in a cylindrical shape and a second housing 7 formed in a cylindrical shape and fixed to an end on one side (left side in FIG. 1) in the shaft direction of the first housing 6. At an end on the other side (right side in FIG. 1) opposite to the second housing 7 of the first housing 6, the pinion shaft 2 is rotatably accommodated in a state of obliquely crossing the rack shaft 3. The rack teeth of the rack shaft 3 and the pinion teeth of the pinion shaft 2 mesh with each other to form a rack and pinion mechanism (not shown). Note that the pinion shaft 2 is coupled to a steering shaft, and a steering wheel is fixed to the tip end of the steering shaft (both the steering shaft and the steering wheel are not shown). Accordingly, in the steering apparatus 1, the pinion shaft 2 rotates with a steering operation, and the rotation is converted into the shaft-direction movement of the rack shaft 3 with the rack and pinion mechanism to change the steering angle of the steering wheel, i.e., the traveling direction of a vehicle.

In addition, the steering apparatus 1 includes a steering force assisting unit 11 that applies an assisting force to a steering system. The steering force assisting unit 11 has an electric motor 12 arranged parallel to the rack shaft 3. The steering force assisting unit 11 is configured to transmit the rotation of the electric motor 12 to a ball screw mechanism 14 via a transmission mechanism 13 and convert the transmitted rotation into the reciprocating movement of the rack shaft 3 with the ball screw mechanism 14 to apply the assisting force to the steering system. That is, the steering apparatus 1 of the embodiment is configured as so-called a rack parallel electric power steering apparatus.

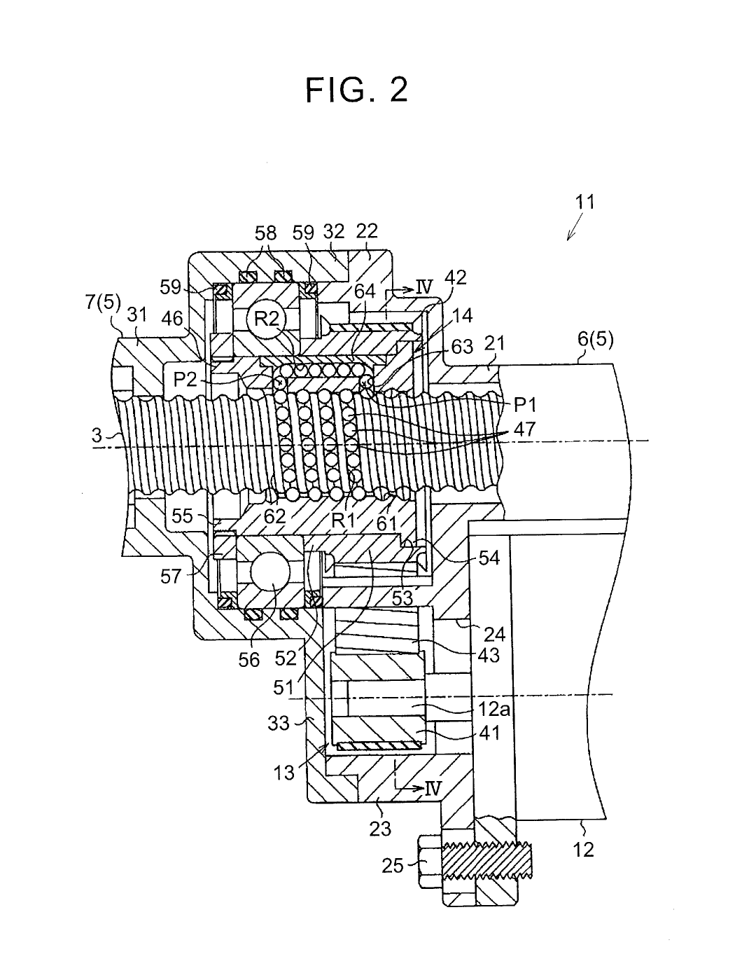

Specifically, as shown in FIG. 2, the first housing 6 has a first cylindrical part 21 formed in a cylindrical shape and a first accommodation part 22 formed at an end of the first cylindrical part 21 on the side of the second housing 7 (left side in FIG. 2). The first accommodation part 22 is formed in a cylindrical shape having a diameter greater than that of the first cylindrical part 21. In addition, the partial peripheral wall of the first accommodation part 22 is formed as a protrusion part 23 having a shape protruding toward a side (lower side in FIG. 2) where the electric motor 12 is arranged. The protrusion part 23 has, at the bottom thereof, an insertion hole 24 penetrating in the shaft direction of the rack shaft 3. Further, the electric motor 12 is fixed to the external bottom face of the protrusion part 23 by a bolt 25, and a rotating shaft 12a of the electric motor 12 is arranged in the protrusion part 23 via the insertion hole 24.

The second housing 7 has a second cylindrical part 31 formed in a cylindrical shape and a second accommodation part 32 formed at an end of the second cylindrical part 31 on the side of the first housing 6 (right side in FIG. 2). The second accommodation part 32 is formed in a cylindrical shape having a diameter greater than that of the second cylindrical part 31. In addition, the second accommodation part 32 has a plate-shaped cover 33 extending to the side of the electric motor 12 to cover the protrusion part 23.

The transmission mechanism 13 includes a driving pulley 41 accommodated inside the protrusion part 23 and coupled to be integrally rotatable with the rotating shaft 12a of the electric motor 12, a driven pulley 42 rotatably accommodated inside the first accommodation part 22 and arranged at the outer periphery of the rack shaft 3, and a belt 43 wound around the driving pulley 41 and the driven pulley 42. Note that the belt 43 is made of an elastic material such as rubber. The ball screw mechanism 14 includes a ball screw nut 46 provided to be integrally rotatable with the driven pulley 42 and a plurality of balls 47. The ball screw nut 46 is screwed with the rack shaft 3 via the plurality of balls 47 to form the ball screw mechanism 14.

More specifically, the driving pulley 41 is formed in a cylindrical shape. Further, the driving pulley 41 is fixed to the outer periphery of the rotating shaft 12a in an integrally rotatable manner such that it is arranged coaxially with the rotating shaft 12a of the electric motor 12.

The driven pulley 42 is formed in a cylindrical shape and has a wound part 51 where the belt 43 is wound an extending part 52 extending from the wound part 51 to the side of the second housing 7. In addition, the driven pulley 42 has a diameter increasing part 53 at the end thereof on the side of the first housing 6. The bore diameter of the diameter increasing part 53 is greater than that of the part of the driven pulley 42 on the side of the second housing 7.

The ball screw nut 46 is formed in a cylindrical shape. In addition, the ball screw nut 46 has, at the end thereof on the side of the first housing 6, an annular flange part 54 extending outward in the radial direction. Note that the outside diameter of the flange part 54 is set to be substantially equal to the bore diameter of the diameter increasing part 53. On the other hand, the ball screw nut 46 has a male screw part 55 at the end thereof on the side of the second housing 7 of the ball screw nut 46.

At the outer periphery of the ball screw nut 46, the driven pulley 42 is fitted to allow the flange part 54 to be arranged in the diameter increasing part 53 and a rolling bearing 56 serving as a bearing is fitted to be next to the extending part 52.

Further, a lock nut 57 is screwed to the male screw part 55, and the driven pulley 42 and the rolling bearing 56 are held between the lock nut 57 and the flange part 54. Thus, the driven pulley 42 and the inner ring of the rolling bearing 56 are fixed to be integrally rotatable with the ball screw nut 46. In a state in which the driven pulley 42 is provided to be integrally rotatable with the ball screw nut 46 as described above, the wound part 51 of the embodiment is arranged in a range from the end of the ball screw nut 46 on the side of the first housing 6 to the vicinity of the central part in the shaft direction thereof, and the belt 43 is arranged to overlap with the above range (range where the wound part 51 is arranged) of the ball screw nut 46 in the shaft direction.

The rolling bearing 56 provided at the outer periphery of the ball screw nut 46 is fixed to be arranged coaxially with the rack shaft 3 inside the second accommodation part 32 of the second housing 7. Thus, the driven pulley 42 and the ball screw nut 46 are accommodated to be rotatable coaxially with the rack shaft 3 inside the rack housing 5. In addition, at the outer periphery of the rolling bearing 56 of the embodiment, an annular elastic member (O-ring) 58 made of an elastic material such as rubber is arranged between the rolling bearing 56 and the second accommodation part 32 in its compressed state. Moreover, on both sides of the rolling bearing 56 in the shaft direction, annular elastic members 59 are arranged between the rolling bearing 56 and the first housing 6 and between the rolling bearing 56 and the second housing 7 in their compressed state. That is, only one end of the ball screw nut 46 is supported by the rolling bearing 56 elastically supported inside the rack housing 5.

Further, at the inner periphery of the ball screw nut 46, a thread groove 61 is formed. Note that the thread groove 61 of the embodiment is a right hand thread groove. Furthermore, the thread groove 61 is formed in a range from the end of the ball screw nut 46 on the side of the first housing 6 to the part thereof slightly before the male screw part 55.

On the other hand, at the outer periphery of the rack shaft 3, a right hand thread groove 62 is formed corresponding to the right hand thread groove 61. Note that the thread groove 62 is formed over a prescribed range substantially equal to the range of the rack shaft 3 where the rack teeth are formed. Further, a spiral ball raceway R1 is formed by the thread grooves 61 and 62. In the ball raceway R1, the balls 47 are provided in a state of being held between the thread groove 61 of the ball screw nut 46 and the thread groove 62 of the rack shaft 3. That is, the ball screw nut 46 is screwed to the outer periphery of the rack shaft 3 via the balls 47.

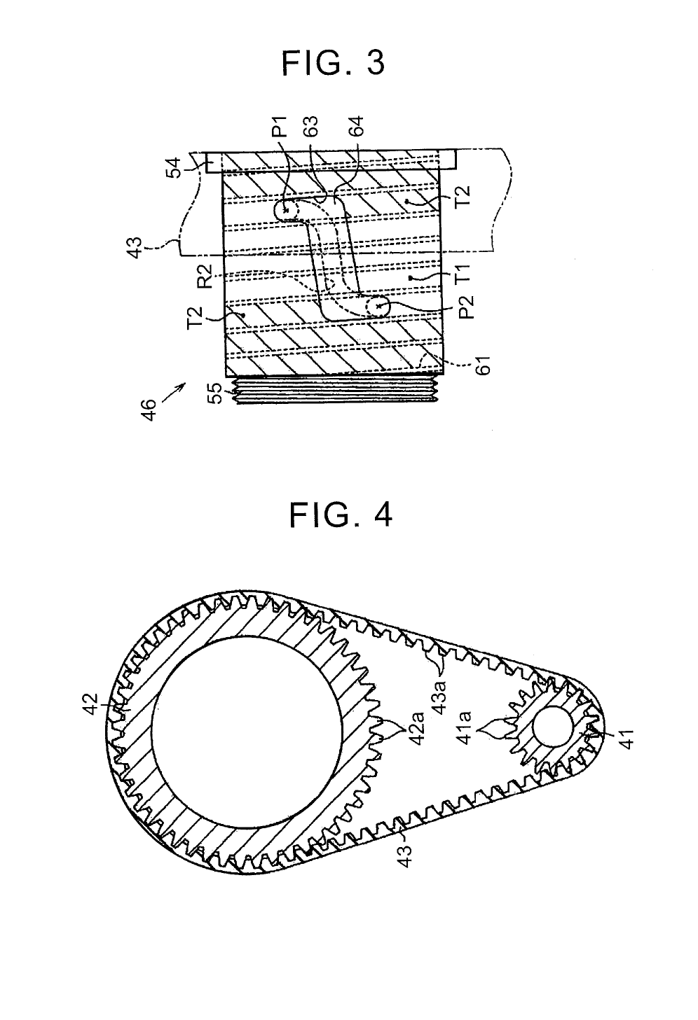

As shown in FIGS. 2 and 3, the ball screw nut 46 has a circulating path R2 that takes a shortcut between connecting points P1 and P2 set at two spots inside the thread groove 62. Specifically, the ball screw nut 46 has an attachment hole 63. The portions of the attachment hole 63 corresponding to the connecting points P1 and P2 penetrate inward and outward. Further, the circulating path R2 is formed with a circulating member (deflector) 64 attached to the attachment hole 63. The circulating member 64 has the function of scooping the balls 47 from the ball raceway R1 and the function of ejecting the balls 47 to the ball raceway R1.

Thus, the thread groove 62 of the ball screw nut 46 has an area between the connecting points P1 and P2 serving as a rolling area T1 where the balls 47 roll and an area other than the rolling area T1 serving as a non-entering area T2 where the balls 47 do not enter. Note that in FIG. 3, only the non-entering area T2 is hatched for the purpose of illustration. In the embodiment, the connecting point P1 on one side is set at a position close to the flange part 54 of the ball screw nut 46, while the connecting point P2 on the other side is set at a position closer to the male screw part 55 than the central part in the shaft direction of the ball screw nut 46. Between the connecting points P1 and P2, the thread groove 62 for a several number of turns is included. Further, since the belt 43 is arranged to overlap with the range from the end of the ball screw nut 46 on the side of the first housing 6 (flange part 54) to the vicinity of the central part in the shaft direction thereof as described above, part of the belt 43 is arranged to overlap with the rolling area T1 in the shaft direction.

In the ball screw mechanism 14 thus formed, when the ball screw nut 46 rotates relative to the rack shaft 3 and the balls 47 receive friction force from the rack shaft 3 and the ball screw nut 46, the balls 47 roll inside the ball raceway R1 to transmit the torque of the ball screw nut 46 to the rack shaft 3, thereby moving the rack shaft 3 in the shaft direction relative to the ball screw nut 46. In addition, the balls 47 having reached one end (connecting point P1 or P2) of the ball raceway R1 after rolling inside the ball raceway R1 pass through the circulating path R2 formed in the ball screw nut 46 to be ejected to the other side (connecting point P2 or P1) of the ball raceway R1. As a result, the balls 47 move from a downstream side to an upstream side in a ball moving direction inside the ball raceway R1. That is, the ball screw mechanism 14 is such that the respective balls 47 rolling inside the ball raceway R1 infinitely circulate via the circulating path R2 to allow the rotation of the ball screw nut 46 to be converted into the shaft-direction movement of the rack shaft 3. Further, the steering apparatus 1 rotary drives the ball screw nut 46 using the electric motor 12 and transmits the torque to the rack shaft 3 as a pressing force in the shaft direction to apply an assisting force for assisting a steering operation to the steering system.

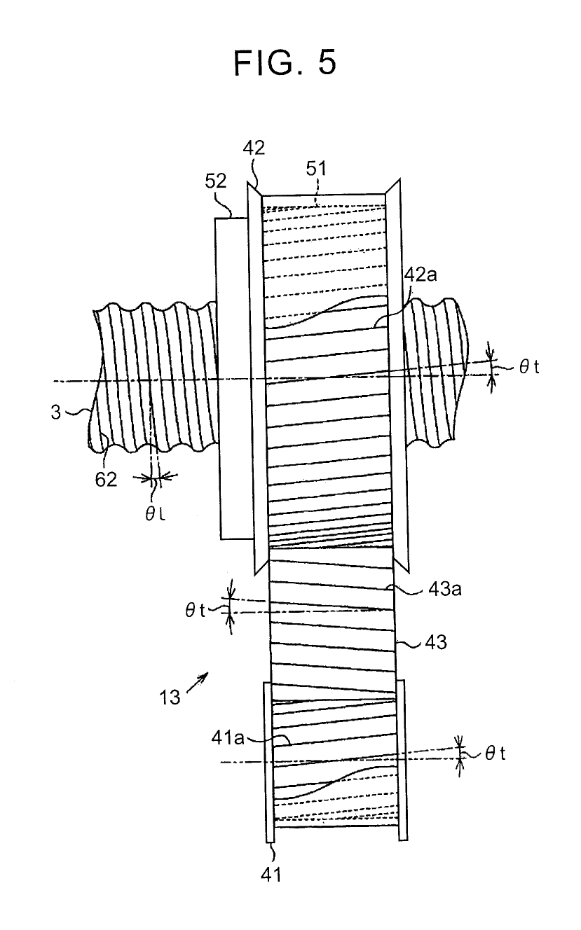

Next, the coupling structure between the driving pulley and the driven pulley and the belt will be described. As shown in FIGS. 4 and 5, the driving pulley 41 has outer teeth 41 a protruding outward in the radial direction. In addition, the wound part 51 of the driven pulley 42 has outer teeth 42a protruding outward in the radial direction. On the other hand, the belt 43 has inner teeth 43a to mesh with the outer teeth 41a and 42a. Further, the belt 43 is wound around the respective pulleys 41 and 42 with the inner teeth 43a meshing with the respective outer teeth 41a and 42a. Note that since the belt 43 is slightly expanded in a state of being wound around the respective pulleys 41 and 42, a prescribed tension is generated in the belt 43. Further, in FIG. 5, only the tooth traces of the outer teeth 41a and 42a and the inner teeth 43a are shown for the purpose of illustration.

Further, the outer teeth 41a and 42a and the inner teeth 43a are configured as left hand helical teeth having tooth traces twisted in a direction opposite to the respective thread grooves 61 and 62. More specifically, helix angles θt of the outer teeth 41a and 42a and the inner teeth 43a are set to be equal to lead angles θ1 of the thread grooves 61 and 62, respectively. Note that the lead angles θ1 of the thread grooves 61 and 62 are the same. In FIG. 5, only the lead angle θ1 of the thread groove 61 of the rack shaft 3 is shown for the purpose of illustration.

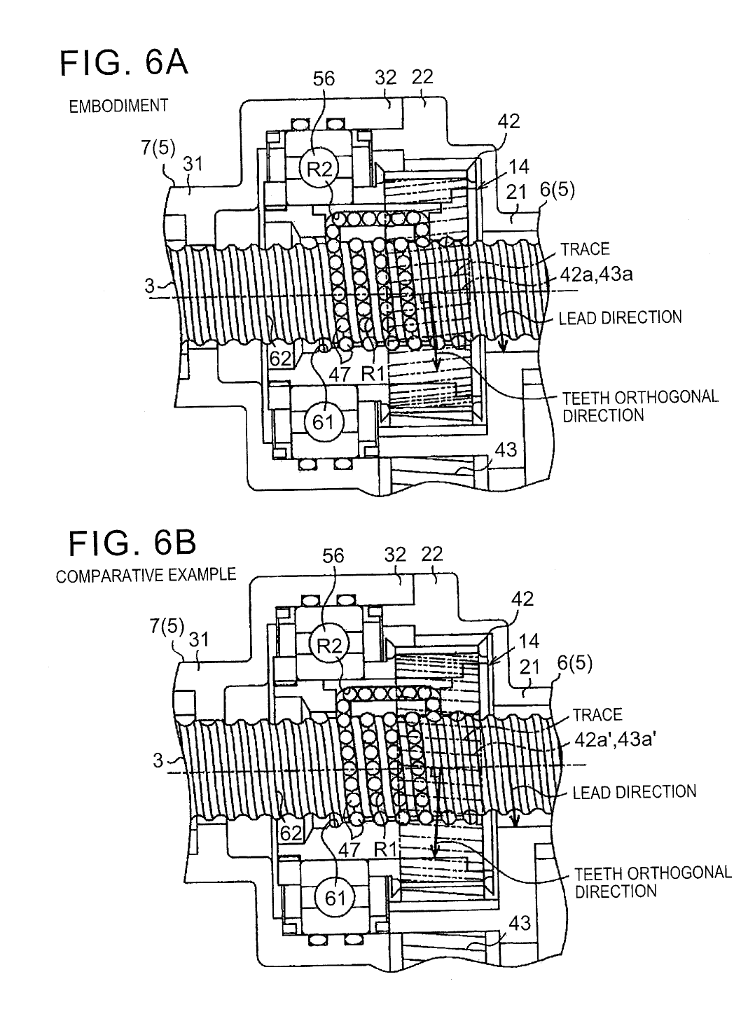

Next, the operation of the embodiment will be described. Since force that the driven pulley 42 receives from the belt 43 acts in a direction (teeth orthogonal direction) orthogonal to the tooth traces of the outer teeth 42a as described in FIG. 6A, the ball screw nut 46 is rotary driven by the force in the teeth orthogonal direction. On the other hand, since the respective balls 47 are arranged in a direction (lead direction) in which the respective thread grooves 61 and 62 extend inside the ball raceway R1 as described above, they roll in the lead direction.

Here, FIG. 6B shows, as a comparative example, a case in which outer teeth 42a′ and inner teeth 43a′ are formed as helical teeth twisted in the same direction as the thread grooves 61 and 62 and thus the teeth orthogonal direction is greatly deviated from the lead direction. In this case, a component of the force in a direction crossing the direction in which the balls 47 roll acts on the ball screw nut 46. In a state in which the teeth orthogonal direction is greatly deviated from the lead direction as described above, the ball screw nut 46 is likely to be inclined toward the rack shaft 3, which may hinder the smooth rotation of the ball screw nut 46.

On the contrary, since the outer teeth 42a and the inner teeth 43a of the embodiment are configured as the helical teeth twisted in the direction opposite to the thread grooves 61 and 62 at the same angle as the lead angles θ1 of the thread grooves 61 and 62 as described above, the teeth orthogonal direction substantially corresponds to the lead direction. Therefore, the component of the force in the direction crossing the direction in which the balls 47 roll hardly acts on the ball screw nut 46, the ball screw nut 46 is effectively prevented from being inclined toward the rack shaft 3, and the ball screw nut 46 is smoothly rotated. Thus, the rotation of the ball screw nut 46 is converted into the shaft-direction movement of the rack shaft 3 with a high degree of efficiency.

Next, the effects of the embodiment will be described. First, the outer teeth 41a and 42a of the respective pulleys 41 and 42 and the inner teeth 43a of the belt 43 are formed as the helical teeth twisted in the direction opposite to the thread grooves 61 and 62. According to this configuration, the rotation of the electric motor 12 can be converted into the reciprocating movement of the rack shaft 3 with a high degree of efficiency. Therefore, even if a downsized and lightweight electric motor that produces low torque is used as the electric motor 12, an adequate amount of assisting force can be applied to the steering system. Accordingly, the steering apparatus 1 can be downsized and reduced in weight with its assisting performance maintained.

In addition, the belt 43 is arranged such that part of the belt 43 overlaps, in the shaft direction, with the rolling area T1 of the thread groove 62 of the ball screw nut 4. According to this configuration, part of the force acting on the ball screw nut 46 from the belt 43 acts on the part of the ball screw nut 46 where the balls 47 exist on the inner periphery side. Here, at the part of the ball screw nut 46 where the balls 47 exist on the inner periphery side, the gap between the ball screw nut 46 and the rack shaft 3 is secured by the balls 47. Therefore, compared with a case in which the entire force acting on the ball screw nut 46 from the belt 43 via the driven pulley 42 acts on the part of the ball screw nut 46 where the balls 47 do not exist on the inner periphery side, the ball screw nut 46 can be prevented from being inclined.

Moreover, only one end of the ball screw nut 46 is rotatably supported by the rolling bearing 56 provided inside the second accommodation part 32 of the rack housing 5. Therefore, compared with a case in which the both ends of the ball screw nut 46 is rotatably supported, the number of parts can be reduced. However, since this configuration supports the ball screw nut 46 at the one end thereof, the ball screw nut 46 is likely to be inclined toward the rack shaft 3. Accordingly, the outer teeth 41a and 42a and the inner teeth 43a are formed as the helical teeth twisted in the direction opposite to the thread grooves 61 and 62, and part of the belt 43 is arranged to overlap with the rolling area T1 of the thread groove 61 in the shaft direction. These configurations produce a great effect to prevent the ball screw nut 46 from being inclined.

Furthermore, since the annular elastic member 58 is provided between the rolling bearing 56 and the second accommodation part 32 of the rack housing 5, the rolling bearing 56 is elastically supported by the elastic member 58 inside the rack housing 5.

Therefore, even if the ball screw nut 46 is decentered relative to the rack shaft 3 due to an assembly error or the like, the smooth rotation of the ball screw nut 46 is possible but the ball screw nut 46 is likely to be inclined toward the rack shaft 3. Accordingly, the outer teeth 41a and 42a and the inner teeth 43a are formed as the helical teeth twisted in the direction opposite to the thread grooves 61 and 62, and part of the belt 43 is arranged to overlap with the rolling area T1 of the thread groove 61 in the shaft direction. These configurations produce a great effect to prevent the ball screw nut 46 from being inclined.

The above embodiment may be appropriately modified and carried out as follows. In the above embodiment, the elastic member 58 is interposed between the rolling bearing 56 and the second accommodation part 32 to elastically support the rolling bearing 56. However, instead of this configuration, the rolling bearing 56 may be rigidly supported inside the second accommodation part 32 without the elastic member 58.

In the above embodiment, only one end of the ball screw nut 46 is rotatably supported by the rolling bearing 56. However, instead of this configuration, both ends of the ball screw nut 46 may be each rotatably supported.

In the above embodiment, the belt 43 is arranged such that part of the belt 43 overlaps with the rolling area T1 of the ball screw nut 46 in the shaft direction. However, instead of this configuration, the belt 43 may be arranged such that the entire belt 43 overlaps with the rolling area T1 of the ball screw nut 46 in the shaft direction.

Further, the belt 43 may be arranged such that the entire belt 43 does not overlap with the rolling area T1 of the ball screw nut 46 in the shaft direction.

In the above embodiment, the helix angles θt of the outer teeth 41a and 42a and the inner teeth 43a are set to be equal to the lead angles θ1 of the thread grooves 61 and 62, respectively. However, instead of this configuration, as long as the tooth traces of the outer teeth 41a and 42a and the inner teeth 43a are twisted in the direction opposite to the thread grooves 61 and 62, the helix angles θt of the outer teeth 41a and 42a and the inner teeth 43a may be set to be different from the lead angles θ1 of the thread grooves 61 and 62, respectively.

In the above embodiment, the steering apparatus 1 is configured such that the rack shaft 3 is allowed to move reciprocally with a steering operation (i.e., the steering apparatus 1 serves mainly as a front-wheel steering apparatus). However, instead of this configuration, the steering apparatus 1 may be configured such that the rack shaft 3 is allowed to move reciprocally only with the torque of the electric motor 12 (i.e., the steering apparatus 1 serves as, for example, a rear-wheel steering apparatus or the like).

1. A steering apparatus comprising:
a driving pulley that rotates with driving of an electric motor;
a driven pulley arranged coaxially with a steering shaft;
a belt wound around the driving pulley and the driven pulley; and
a ball screw mechanism that converts a rotation of the driven pulley into a reciprocating movement of the steering shaft, wherein:
the ball screw mechanism includes a ball screw nut that integrally rotates with the driven pulley, and a plurality of balls provided inside a spiral ball raceway formed by a first thread groove formed at an outer periphery of the steering shaft and a second thread groove formed at an inner periphery of the ball screw nut, the first thread groove and the second thread groove facing each other;
the driving pulley and the driven pulley respectively have outer teeth at outer peripheries thereof, and the belt has, at an inner periphery thereof, inner teeth configured to mesh with the respective outer teeth; and
the first thread groove and the second thread groove are both configured to be one of (i) right-hand helical and (ii) left-hand helical, and the respective outer teeth and the inner teeth are helical teeth both configured to be the other of (i) right-hand helical and left-hand helical.

2. The steering apparatus according to claim 1, wherein helix angles of the respective outer teeth and the inner teeth are respectively set to be equal to lead angles of the first thread groove and second thread groove.

3. The steering apparatus according to claim 1, wherein:
the ball screw nut has a circulating path defining a shortcut between two points of the second thread groove to allow an infinite circulation of the balls rolling inside the ball raceway; and
the belt is arranged such that at least part of the belt overlaps, in a an axial direction of the steering shaft, with a rolling area of the second thread groove where the balls roll.

4. The steering apparatus according to claim 1, wherein:
a bearing is provided inside a housing that accommodates the steering shaft such that the steering shaft is allowed to move reciprocally; and
the ball screw nut is configured such that only one end of the ball screw nut is rotatably supported by the bearing.

5. The steering apparatus according to claim 4, wherein a first annular elastic member is provided between an outer periphery of the bearing and the housing.

6. The steering apparatus according to claim 4, wherein second annular elastic members are provided between both sides of the bearing in an axial direction of the steering shaft and the housing.

7. A steering apparatus comprising:
a driving pulley that rotates with driving of an electric motor;
a driven pulley arranged coaxially with a steering shaft;
a belt wound around the driving pulley and the driven pulley; and
a ball screw mechanism that converts a rotation of the driven pulley into a reciprocating movement of the steering shaft, wherein:
the ball screw mechanism includes a ball screw nut that integrally rotates with the driven pulley, and a plurality of balls provided inside a spiral ball raceway formed by a first thread groove formed at an outer periphery of the steering shaft and a second thread groove formed at an inner periphery of the ball screw nut, the first thread groove and the second thread groove facing each other and defining a lead direction in which the balls roll when the ball screw nut rotates;
the driving pulley and the driven pulley respectively have outer teeth at outer peripheries thereof, and the belt has, at an inner periphery thereof, inner teeth configured to mesh with the respective outer teeth; and
the outer teeth of the driven pulley are helical teeth having tooth traces inclined at an angle so that an orthogonal direction of the driven pulley outer teeth corresponds substantially to the lead direction.

8. A steering apparatus comprising:
a driving pulley that rotates with driving of an electric motor;
a driven pulley arranged coaxially with a steering shaft, the steering shaft having a threaded groove on its outer periphery that is inclined at a lead angle;
a belt wound around the driving pulley and the driven pulley, the driving pulley and the driven pulley respectively having outer teeth at outer peripheries thereof, and the belt having, at an inner periphery thereof, inner teeth configured to mesh with the respective outer teeth; and
a ball screw mechanism that converts a rotation of the driven pulley into a reciprocating movement of the steering shaft,
wherein at least the outer teeth of the driven pulley are helical teeth having tooth traces inclined at a helix angle that is the same as the lead angle of the threaded groove of the steering shaft.

9. The steering apparatus of claim 8, wherein at least the outer teeth of the driving pulley are helical teeth having tooth traces inclined at a helix angle that is the same as the lead angle of the threaded groove of the steering shaft.

10. The steering apparatus of claim 8, wherein at least the inner teeth of the belt are helical teeth having tooth traces inclined at a helix angle that is the same as the lead angle of the threaded groove of the steering shaft.

11. The steering apparatus of claim 8, wherein the helix angle of the driven pulley outer teeth is set so that an orthogonal direction of the outer teeth corresponds substantially to a lead direction of the threaded groove.

12. The steering apparatus of claim 8, wherein the outer teeth of the driven pulley are configured to be one of (i) right-hand helical and (ii) left-hand helical, and the threaded groove of the steering shaft is configured to be the other of (i) right-hand helical and (ii) left-hand helical.
